(19) United States
(12) Patent Application Publication
(10) Pub. No.: US 2025/0256595 A1
(43) Pub. Date: Aug. 14, 2025

(54) RECHARGING UNIT OF AN ELECTRICALLY-POWERED MOTOR-VEHICLE

(71) Applicant: Stellantis Europe S.p.A., Torino (IT)

(72) Inventors: Leonardo BIANCO, Torino (IT); Salvatore BRUNO, Torino (IT); Gaetano CARBONE, Torino (IT); Maurizio DELMONTE, Torino (IT); Giovanni ESPOSITO, Torino (IT); Guiscardo MASTRANTUONO, Torino (IT); Fabiana ROMANIELLO, Torino (IT)

(73) Assignee: Stellantis Europe S.p.A., Torino (IT)

(21) Appl. No.: 18/867,203

(22) PCT Filed: May 8, 2023
(86) PCT No.: PCT/IB2023/054740

§ 371 Date: Nov. 19, 2024

(30) Foreign Application Priority Data
May 19, 2022 (IT) 102022000010385

(51) Int. Cl. B60L 53/20

(52) U.S. Cl. CPC B60L 53/20

(57) ABSTRACT

A recharging unit for one or more batteries of an electrically-powered motor-vehicle is permanently arranged on board the motor-vehicle.

An electrical connector is carried by a recharging cable, provided for connection to an external electrical socket.

A hollow support and containment body is configured to house the recharging cable and the electrical connector.

The hollow support and containment body defines a cavity, a proximal portion, and a distal portion, wherein said the proximal portion has an opening for enabling manually picking-up the electrical connector.

A further electrical connector is supported by the hollow support and containment body and arranged to receive a corresponding connector element for connection to the respective electronic components for managing the motor-vehicle batteries.

### FIELD OF THE INVENTION

This invention relates to a recharging unit for one or more batteries of an electrically-powered motor-vehicle, permanently arranged on board the motor-vehicle.

### PRIOR ART

As known in the sector in question, the recharging of a battery pack of an electrically-powered vehicle takes place by means of electrical connectors configured to ensure safe and effective recharging.

Depending on the recharging equipment, the connectors can be of the traditional type, for example sockets for domestic use, or connectors for industrial use. Usually, the first solution is used in areas with access reserved for the vehicle owner, while the second solution is preferable in the public sphere.

One of the most widespread solutions concerns the arrangement of recharging columns which include within them an electrical connection cable and a connector provided with electrical terminals to be connected to a corresponding connector element on board the motor-vehicle.

This invention starts from the desire to create a solution for recharging an electric or hybrid vehicle which is relatively simple to implement and low-cost, compatible with the overall dimensions and installation spaces available on board the motor-vehicle.

### OBJECT OF THE INVENTION

The object of this invention is to provide a recharging unit of the type indicated at the beginning of the present disclosure, having a relatively simple and low-cost structure, while allowing recharging operations to be performed intuitively and effectively.

A further object of the invention is to provide a modular recharging unit, adaptable for different types of recharging connectors.

A further object of the invention is to provide a unit of the type indicated above, compatible with the overall dimensions and installation spaces available on board the motor-vehicle, for example at the engine compartment.

### SUMMARY OF THE INVENTION

In view of achieving one or more of the said objects, the invention relates to a recharging unit for one or more batteries of an electrically-powered motor-vehicle, permanently arranged on board said motor-vehicle, wherein said recharging unit comprises:
an electrical connector carried by a recharging cable, provided for connection to an external electrical socket,
a hollow support and containment body configured to house said recharging cable and said electrical connector,
wherein said hollow support and containment body defines a cavity, a proximal portion, and a distal portion, wherein said proximal portion has an opening for enabling manually picking-up said electrical connector,
a further electrical connector supported by said hollow support and containment body at said distal portion, wherein said further electrical connector is connected to said recharging cable at an end opposite to said electrical connector and is arranged to receive a corresponding connector element for connection to respective electronic components for managing the motor-vehicle batteries.

Further features of the invention are indicated in the attached dependent claims.

### BRIEF DESCRIPTION OF THE FIGURES

Further features and advantages of the invention will emerge from the following description with reference to the attached drawings, provided purely by way of non-limiting example, in which:

FIGS. 1A, 1B are respectively a general perspective view of a motor-vehicle and a perspective view, on an enlarged scale, of an area of the motor-vehicle at which a recharging unit is mounted according to a preferred embodiment,

FIGS. 2, 3 are respectively a perspective view and a sectional view of the recharging unit according to a preferred embodiment,

FIGS. 4, 5 are perspective views, on an enlarged scale, illustrating various components illustrated in FIGS. 2, 3,

FIG. 6 is a further perspective view of the recharging unit according to a preferred embodiment,

FIG. 7 is a view, on enlarged scale, of some components illustrated in the previous figure, and

FIG. 8 is an exploded perspective view illustrating further features of the invention.

### DETAILED DESCRIPTION OF SEVERAL EMBODIMENTS

Various specific details are illustrated in the following description aimed at an in-depth understanding of examples of one or more embodiments. Embodiments may be made without one or more of the specific details, or with other methods, components, materials, etc. In other cases, known structures, materials or operations are not shown or described in detail to avoid obscuring various aspects of the embodiments. Reference to “an embodiment” or “one embodiment” in the framework of the present description is intended to indicate that a particular configuration, structure, or feature described in connection with the embodiment is included in at least one embodiment. Thus, phrases such as “in an embodiment” or “in one embodiment,” that may be present in one or more points of the present description do not necessarily refer to one and the same embodiment. Moreover, particular conformations, structures, or features may be combined in any adequate way in one or more embodiments and/or associated with the embodiments in a manner other than as illustrated herein, so that for example a feature, exemplified herein in relation to a figure, can be applied to one or more embodiments exemplified in a different figure.

The headings/references used herein are provided merely for convenience and hence do not define the extent of protection or the scope of the embodiments.

In the accompanying drawings, the number 1 indicates as a whole a recharging unit for one or more batteries of an electric or hybrid motor-vehicle V, permanently arranged on board the motor-vehicle V.

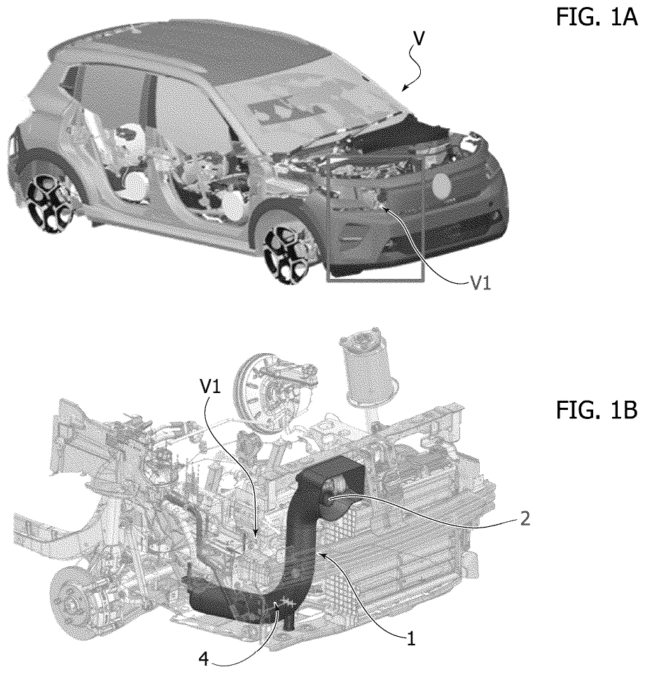

FIGS. 1A, 1B are respectively a general perspective view of a motor-vehicle V and a perspective view, on an enlarged scale, of an area of the motor-vehicle V at which the recharging unit 1 is mounted. According to a preferred embodiment, the recharging unit 1 is mounted on board the motor-vehicle V at a front portion V1 substantially corresponding to a lateral portion of the engine compartment. However, it should be noted that the unit 1 can be installed in other positions, for example in a rear area of the vehicle, in the load compartment, near a rear fog light element, in a side area of the vehicle, etc.

The recharging unit 1 can be used to recharge various types of battery cells and/or modules, constituting battery packs for powering a purely electric or hybrid propulsion system.

According to this invention, the recharging unit 1 comprises a hollow support and containment body 4 configured to internally house a recharging cable 3 on which an electrical connector 2 is provided for connection to an electrical socket outside the motor-vehicle V. It should be noted that the electrical connector 2 can be of a different type to that schematically illustrated, depending on the respective coupling with an external recharging socket.

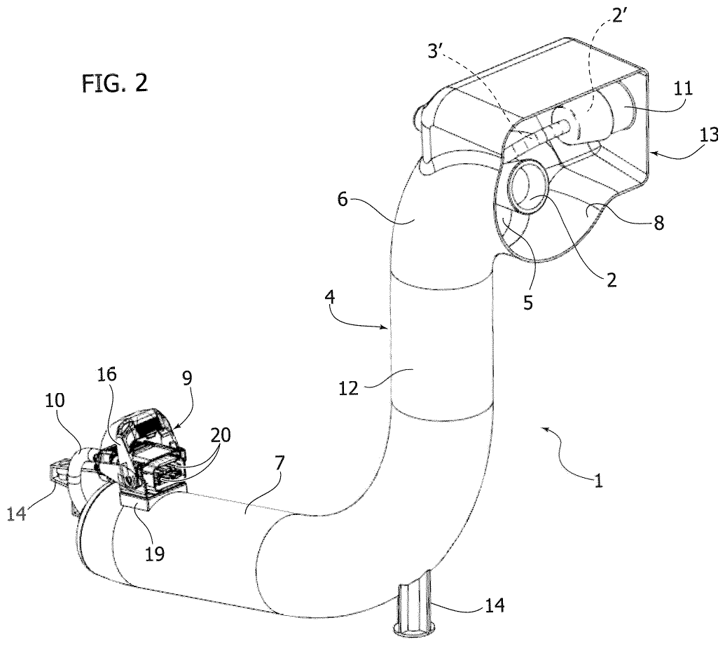

According to the embodiment illustrated, particularly in FIG. 2, the support and containment body 4 is substantially shaped like a tube, defining a cavity 5 within which are arranged: the recharging cable 3, a distal portion 7, and a proximal portion 6 which has an opening 8 for enabling manually picking-up the electric connector 2 to carry out the connection to the external electric socket (not shown).

According to the illustrated embodiment, the support and containment body 4 has a curved shape, in which a substantially vertical intermediate portion 12 is provided between the proximal portion 6 and the distal portion 7 (with reference to the configuration installed on board the motor-vehicle), so as to provide a substantially S-shaped body 4. The distal portion 7 defines a substantially horizontal section and the proximal portion 6 comprises a head portion 13 on which the said opening 8 is obtained, from which it is possible to pick up the electrical connector 2.

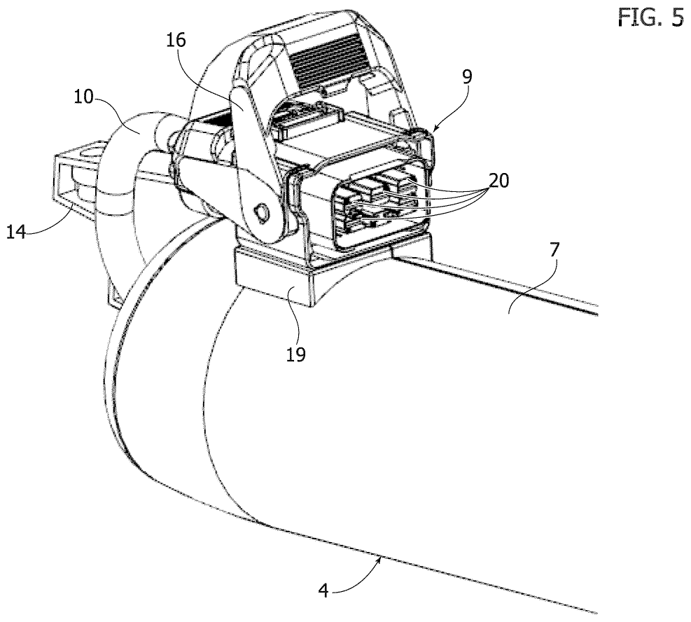

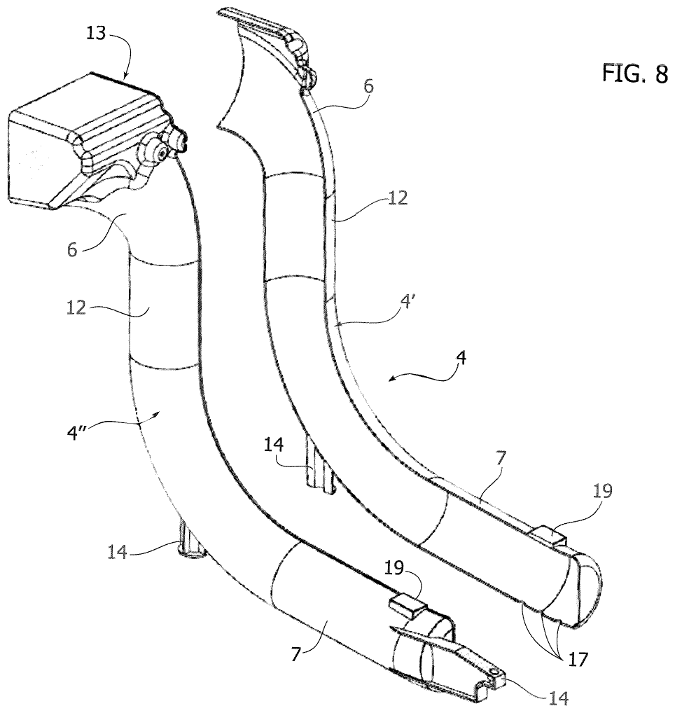

In one or more embodiments, as illustrated in FIG. 8, the hollow support and containment body 4 is formed by two half-shells 4′, 4″, for example made of plastic material, which can be coupled together with mutual fixing means, so as to form the tube-shaped body and the cavity 5 within which the recharge cable 3 is arranged. Preferably, the support and containment body 4 has a circular section. With reference to FIG. 5, it should be noted that the support and containment body 4 comprises mounting portions 14 arranged to secure in place the support and containment body 4 to the chassis of the motor-vehicle. For example, the mounting portions comprise connection elements in the vicinity of the intermediate portion 12 and of the distal portion 7, provided for connection to a lower portion of the chassis of the motor-vehicle V, by means of mutual fixing means.

The recharging unit 1 also comprises a further electrical connector 9 connected to the recharging cable 3 at an end 10 opposite to the electrical connector 2 facing the opening 8 for the manual pick-up. The said additional electrical connector 9 is arranged to receive a corresponding connector 15 element (not shown) for connection to respective electronic components for managing the batteries mounted on the motor-vehicle V. As illustrated in the enlarged scale view of FIG. 5, the said additional electrical connector 9 is externally supported by said hollow support and containment body 4 at the distal portion 7. More specifically, a securing seat 19 is applied to the external wall of the body 4, to receive the said further electrical connector 9. According to the illustrated example, the further electrical connector 9 has a plurality of electrical terminals 20 provided for connection with respective terminals of the corresponding connector element. The further connector 9 also comprises a mechanical arm 16 arranged to be moved with a rotation of approximately 90° to achieve the mechanical coupling with the corresponding connector element (not shown). It should be noted that the electric cable 3 protrudes from the containment body 4 at an end wall of the body 4, with a substantially circular trajectory to reach the further electric connector 9 mounted above and outside the body 4.

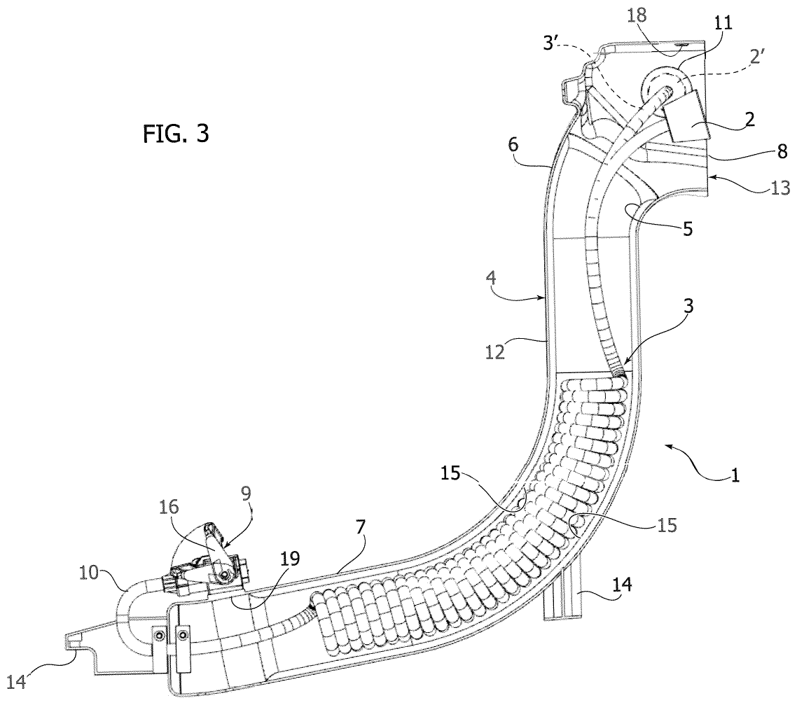

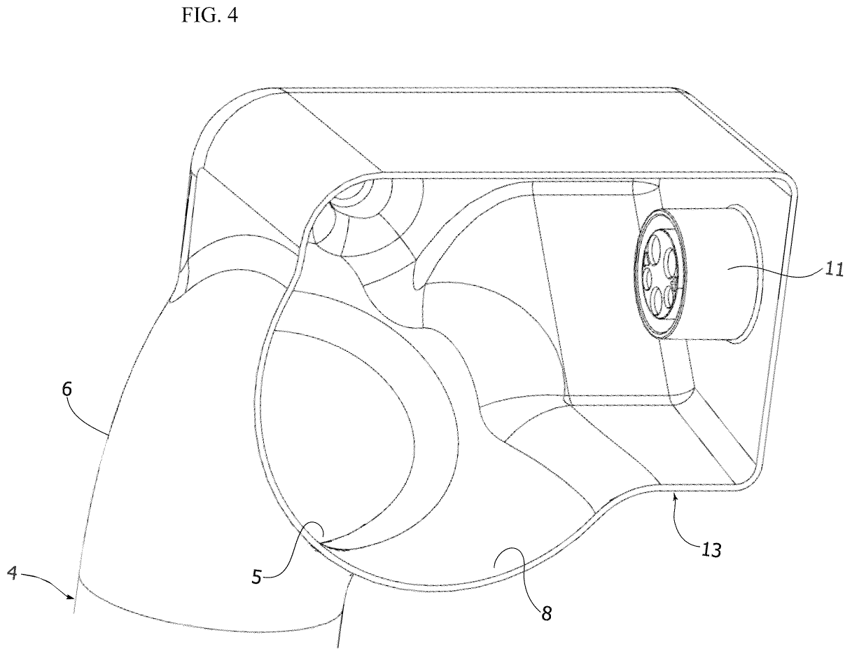

According to a further feature illustrated in FIG. 3, the support and containment body 4 has an internal coating layer 15 applied along the internal surface of the body 4, so as to create a layer interposed between the recharging cable 3 and the material of which the body 4 is made. Thanks to this feature, it is possible to drastically reduce any noise during the movement of the motor-vehicle (due to the contact of the internal wall of the body 4 with the cable 3), as well as to reduce the friction (again for the contact of the internal wall of the body 4 with the cable 3) during the handling of the recharging cable 3 for the manual pick-up of the connector 2. According to an exemplary embodiment, the internal coating layer 15 is made of a material for acoustic insulation, for example of the elastomer type.

As illustrated in FIG. 2, the recharging cable 3 is a spiral cable providing, in a rest position, a spiral pattern between the proximal portion 6 and the distal portion 7, i.e. between the two connectors 2, 9, in which the spiral cable has a spiral pattern substantially coaxial with respect to the support and containment body 4. In one or more embodiments, the overall length of the recharging cable 3 is between 3 and 7 metres. Thanks to the arrangement of the spiral shape of the cable 3 and of the containment body 4, it is possible to arrange electric cables of significant length on board the motor-vehicle in a compact and safe way. As illustrated in FIG. 3, the recharging cable 3 has, at the ends of the spiral portion, a respective substantially straight portion connected to the respective connector 2, 9.

According to a feature of the invention, a receiving seat 11 is formed within the head portion 13, arranged to receive and secure the electrical connector 2 in a rest position, when the connector 2 is not used to carry out a recharging operation. This receiving seat 11 is configured in such a way that the connector 2 is housed on the seat 11, avoiding the making of noise in the passenger compartment due to movements of the recharging cable 3 and of the connector 2, for example, while the motor-vehicle is in motion. The reference numbers 2′, 3′ respectively indicate the cable and the connector in the rest position on the receiving seat 11. It should be noted that the receiving seat 11 is substantially shaped to reproduce the shape of the electrical connector 2 in negative. In the embodiment illustrated in the drawings, the receiving seat 11 is arranged inside the head portion 13, protruding from a side wall substantially perpendicular to the opening 8.

In operation, a user who has to carry out a recharging operation proceeds with the opening of a mobile door (not shown), applied at the opening 8, so as to be able to access the recharging cable 3 and the connector 2 present inside the support and containment body 4. The operator proceeds with the manual pick-up of the connector 2 from the seat 11, to carry out the connection to an external recharging socket, exploiting the spiral shape and the overall length of the recharging cable 3.

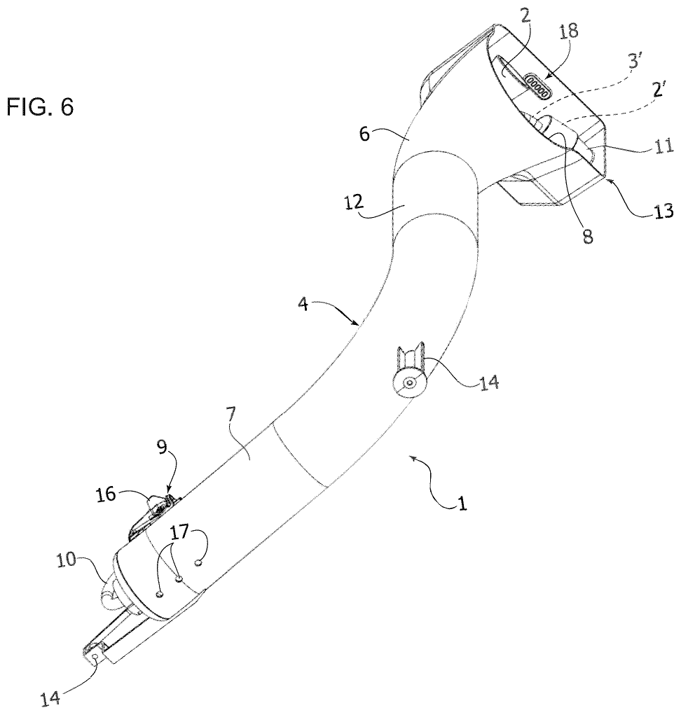

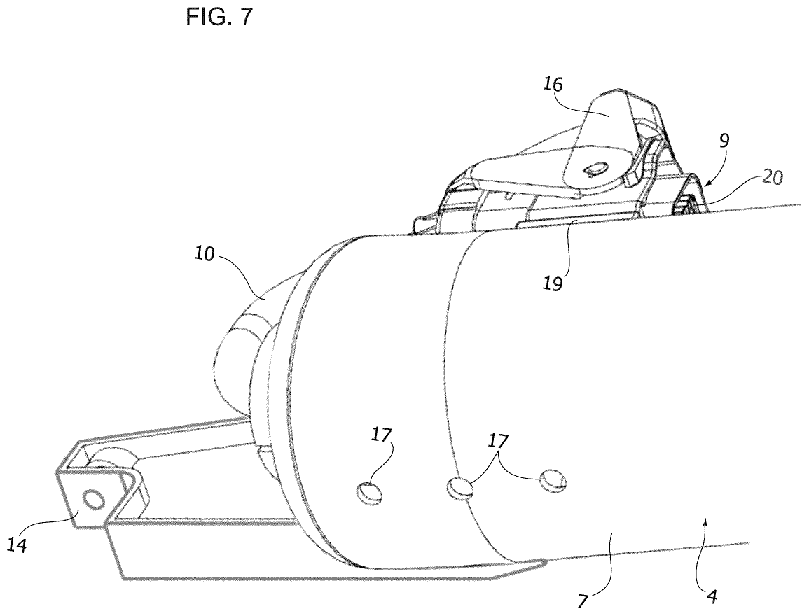

According to a further feature illustrated in FIGS. 6, 7, the support and containment body 4 has at least one drainage opening 17 configured to avoid storage of aqueous residues within the body 4, which could damage the recharging cable 3 and/or the connector 2. This feature is to be considered particularly advantageous given that, during use, the cable 3 and the connector 2 can accumulate humidity from the external environment in which the recharging socket to be connected to the connector 2 is arranged. According in the illustrated embodiment, at a lower area (with reference to the installed configuration) of the distal portion 7, there are a plurality of drainage openings 17 spaced along a horizontal section of the body 4. These drainage openings 17 can be also made of a material suitable for allowing the passage of water/humidity only out of the body 4 and not in.

According to a further feature illustrated in FIG. 6, at the head portion 13 there are a plurality of lighting sources 18, for example LEDs, to illuminate the pick-up area of the electrical connector 2 and/or represent the current state of recharging of the vehicle batteries (for example, with a succession of LEDs which can emit a light source of different colors—green, yellow, red—). According to a preferred illustrated example, the light sources 18 are applied within the head portion 13 at an upper wall, so as to emit a light source in the direction of the electrical connector 2. Naturally, the configuration of the light source shown in the drawings is provided here by way of example only.

Naturally, without prejudice to the principle of the invention, the details of construction and the embodiments may vary widely with respect to what has been described and illustrated purely by way of example, without thereby departing from the scope of this invention.

1. Recharging unit for one or more batteries of an electrically-powered motor-vehicle, permanently arranged on board said motor-vehicle, wherein said recharging unit comprises:
an electrical connector carried by a recharging cable, provided for connection to an external electrical socket,
a hollow support and containment body configured to house said recharging cable and said electrical connector,
wherein said hollow support and containment body defines a cavity, a proximal portion, and a distal portion, wherein said proximal portion has an opening for enabling manually picking-up said electrical connector,
a further electrical connector supported by said hollow support and containment body at said distal portion, wherein said further electrical connector is connected to said recharging cable at an end opposite to said electrical connector and is arranged to receive a corresponding connector element for connection to respective electronic components for managing the motor-vehicle batteries.

2. Recharging unit according to claim 1, wherein the support and containment body defines a tube-shaped body substantially with “S” shape.

3. Recharging unit (1) according to any of the previous claims, wherein the support and containment body (4) is formed by two half-shells (4′, 4″) which can be coupled together with mutual fixing means.

4. Recharging unit (1) according to any of the previous claims, wherein said support and containment body (4) comprises an internal coating layer (15) applied along the internal surface of the body (4), so as to create a layer of acoustic insulation and friction reduction, placed between the recharging cable (3) and the material forming the body (4).

5. Recharging unit (1) according to any of the previous claims, wherein the recharging cable (3) is a spiral cable providing, in a rest position, a spiral pattern substantially coaxial with respect to the support and containment body (4).

6. Recharge unit (1) according to any of the previous claims, comprising a receiving seat (11) arranged to receive and secure the electrical connector (2) in a rest position, when the connector (2) is not used to carry out a recharging operation, wherein said receiving seat (11) is arranged in proximity of the opening (8), and is substantially shaped to reproduce the shape of the electrical connector (2) in negative.

7. Recharging unit (1) according to any of the previous claims, wherein said further electrical connector (9) is supported externally by said hollow support and containment body (4) at the distal portion (7), wherein said further connector (9) comprises a mechanical arm (16) arranged to be moved in rotation to achieve the mechanical coupling with the corresponding connector element.

8. Recharging unit (1) according to any of the previous claims, wherein the support and containment body (4) has at least one drainage opening (17) configured to avoid storage of aqueous residues within the body (4), wherein said at least one drainage opening (17) is formed at a lower area of the distal portion (7).

9. Recharge unit (1) according to any of the previous claims, comprising a plurality of lighting sources (18), for example LEDs, to illuminate the pick-up area of the electrical connector (2) and/or represent the current recharging state of the motor-vehicle batteries.

10. Electrically-powered motor-vehicle comprising a recharging unit for one or more batteries, permanently arranged on board said motor-vehicle, wherein said recharging unit comprises:
an electrical connector carried by a recharging cable, provided for connection to an external electrical socket,
a hollow support and containment body configured to house said recharging cable and said electrical connector,
wherein said hollow support and containment body defines a cavity, a proximal portion, and a distal portion, wherein said proximal portion has an opening for enabling manually picking-up said electrical connector,
a further electrical connector supported by said hollow support and containment body at said distal portion, wherein said further electrical connector is connected to said recharging cable at an end opposite to said electrical connector and is arranged to receive a corresponding connector element for connection to respective electronic components for managing the motor-vehicle batteries.
